(19) United States
(12) Patent Application Publication
(10) Pub. No.: US 2020/0092844 A1
(43) Pub. Date: Mar. 19, 2020

(54) COMMUNICATION TERMINAL DEVICE, COMMUNICATION SYSTEM AND COMMUNICATION METHOD

(71) Applicant: INDUSTRIAL TECHNOLOGY RESEARCH INSTITUTE, Hsinchu (TW)

(72) Inventors: Phone Lin, Hsinchu (TW); Chia-Peng Lee, Hsinchu (TW); Jen-Feng Huang, Hsinchu (TW)

(21) Appl. No.: 16/218,603

(22) Filed: Dec. 13, 2018

(30) Foreign Application Priority Data
Sep. 18, 2018 (TW) 107132786

(51) Int. Cl. H04W 68/02; H04W 60/06; H04W 28/02; H04W 52/02; H04W 8/08; H04L 29/06; H04W 8/04; H04W 4/80

(52) U.S. Cl. CPC H04W 68/02; H04W 60/06; H04W 28/0284; H04W 4/80; H04W 8/08; H04L 65/1006; H04W 8/04; H04W 52/0274

(57) ABSTRACT

A communication terminal device, a communication system and a communication method are provided. The communication terminal device includes a first communication chip, a second communication chip and a switching unit. When detecting an Internet telephone packet or a network traffic greater than a threshold, the switching unit turns off a first communication chip and turns on a second communication chip to enable the Internet telephone packet or the network traffic to be transmitted from the Internet to the second communication chip. When receiving an Internet telephone packet or a paging, the first communication chip is detached from a core network and issues a notification. The switching unit enables the second communication chip to be attached to the core network in response to the notification to enable the Internet telephone packet or the network traffic to be transmitted from the core network to the second communication chip.

### CROSS-REFERENCE TO RELATED APPLICATIONS

This application claims priority to Taiwanese Application Serial No. 107132786, filed on Sep. 18, 2018. The entirety of the above-mentioned patent application is hereby incorporated by reference herein and made a part of this specification.

### BACKGROUND

### 1. Technical Field

This disclosure relates to communication terminal devices, communication systems and communication methods, and, more particularly, to a communication terminal device, a communication system and a communication method receiving an Internet telephone packet or a large network traffic.

### 2. Description of Related Art

Currently, a wearable device can support more and more communication protocols, such as WiFi, Bluetooth and Zigbee supporting short distance communication and Long Term Evolution (LTE) supporting long distance communication. The modern wearable device, though supporting a variety of communication protocols, consumes a great amount of power.

For example, LTE is one of the high-speed communication protocols that are used between mobile phones and data terminals in communication technology fields, and uses a circuit switched function to notify a communication terminal device of a voice phone and require the communication terminal device to make a phone in a 3G network. Such technology is called CS Fallback. In order to achieve the function of CA fallback, a communication terminal device is required to be registered to LTE and 3G network.

Narrow Band Internet of Thing (NB-IoT) is a new technique designed based on 3GPP international standard, and is one of the Low Power Wide Area Network (LPWAN) techniques. NB-IoT can cooperate with cellular network infrastructure. NB-IoT can be connected to a great number of Internet of Things devices, cover a great area, consume less power and thus has a long battery life, and has a low cost.

However, a wearable device, if connected to the NB-IoT network and the LTE network at the same time, will consume more power, such that the power consumption problem is incurred.

Therefore, how to provide a communication terminal device or a communication method that combines the advantages of NB-IoT and LET and also overcomes the limitations of power constraints, has become one of the most urgent issues in the field.

### SUMMARY

This disclosure provides a communication terminal device, comprising: a first communication chip; a second communication chip; and a switching unit for detecting an Internet telephone packet or a network traffic, wherein the first communication chip is turned off or in a sleep mode and the second communication chip is turned on to allow the Internet telephone packet or the network traffic to be transmitted from an Internet to the second communication chip if the network traffic greater than a threshold or the Internet telephone packet is detected; or, otherwise, the second communication chip is turned off or in the sleep mode and the first communication chip is turned on.

This disclosure further provides a communication terminal device, comprising: a first communication chip detached from a core network and emitting a notification when a network traffic greater than a threshold, an Internet telephone packet, or a paging being received; a second communication chip; and a switching unit, in response to the notification issued by the first communication chip, enabling the second communication chip to be attached to the core network to allow the Internet telephone packet or the network traffic to be transmitted from the core network to the second communication chip.

This disclosure also provides a communication system, comprising: a database, comprising association information having a first identification code and a second identification code; and a communication module for searching the database for the association information when receiving an Internet telephone packet having the second identification code to obtain a first identification code associated with the second identification code, and transforming the Internet telephone packet having the second identification code into an Internet telephone packet having the first identification code when the first communication chip of the communication terminal device is in an active mode or in a non-idle mode and transferring the Internet telephone packet having the first identification code to the first communication chip, and the communication module further transferring an Internet telephone packet having the second identification code to a second communication chip when the second communication chip of the communication terminal device is still attached to the communication system.

This disclosure still provides a communication method, comprising: after a core network receiving an Internet telephone packet or a network traffic greater than a threshold, the core network transferring the Internet telephone packet or the network traffic or transmitting a paging to a first communication chip of a communication terminal device; the first communication chip being detached from the core network; switching from the first communication chip to a second communication chip; the second communication chip being attached to the core network; and transmitting the Internet telephone packet or the network traffic from the core network to the second communication chip.

### BRIEF DESCRIPTION OF DRAWINGS

The disclosure can be more fully understood by reading the following detailed description of the preferred embodiments, with reference made to the accompanying drawings, wherein:

FIG. 1 is a schematic diagram of a communication terminal device according to an embodiment of the present disclosure;

FIG. 2 is a schematic diagram of a communication method according to an embodiment of the present disclosure;

FIG. 3 is a schematic diagram of a communication terminal device according to another embodiment of the present disclosure;

FIG. 4 is a schematic diagram of a communication method according to another embodiment of the present disclosure;

FIG. 5 is a schematic diagram of a communication system according to an embodiment of the present disclosure;

FIG. 6 is a schematic diagram of a communication method according to another embodiment of the present disclosure;

FIG. 7 is a schematic diagram of a communication system and a communication method according to an embodiment of the present disclosure;

FIG. 8 is a schematic diagram of a communication system and a communication method according to another embodiment of the present disclosure;

FIG. 9 is a schematic diagram of a communication system and a communication method according to another embodiment of the present disclosure;

FIG. 10 is a schematic diagram of a communication system and a communication method according to yet another embodiment the present disclosure; and

FIG. 11 depicts association information of a first identification code and a second identification code in a communication system and a communication method according to the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

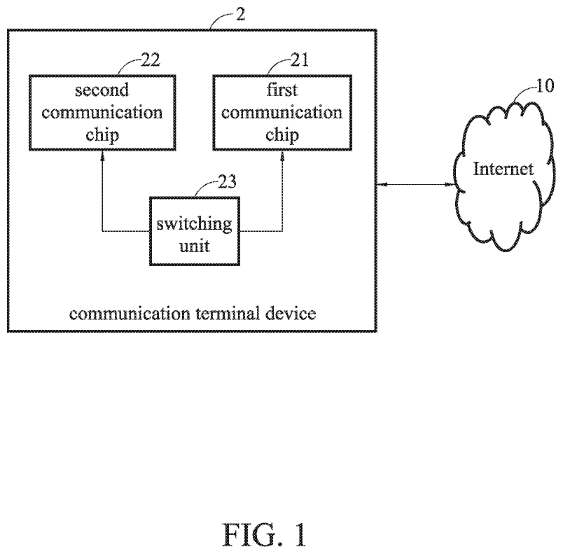

Referring to FIG. 1, a communication terminal device 2 includes a first communication chip 21, a second communication chip 22 and a switching unit 23 according to an embodiment of the present disclosure.

The switching unit 23 detects whether an Internet telephone packet from Internet 10 or a network traffic from the Internet 10 becomes greater. When receiving the Internet telephone packet from the Internet 10 or the network traffic from the Internet 10 being greater than a threshold (e.g., uplink rate 64 Kbit/s or downlink rate 28 Kbit/s), the switching unit 23 turns off a first communication chip 21 or enables the first communication chip 21 to enter a sleep mode and turns on a second communication chip 22, the Internet telephone packet or the network traffic is enabled to be allowed to enter the second communication chip 22. On the contrary, when no Internet telephone packet is received from the Internet 10 or the network traffic from the Internet 10 is not greater than the threshold, the switching unit 23 turns off the second communication chip 22 or enables the second communication chip 22 to enter the sleep mode and turns on the first communication chip 21, so that the communication terminal device 2 operates by using the first communication chip 21.

The communication terminal device 2 may be a wearable device or a portable device, including an electronic device, such as a mobile phone with communication functions. The Internet telephone packet is referred to a packet based on a Session Initial Protocol (SIP). The first communication chip 21 may be a power-saving chip, such as a Narrow Band Internet of Things (Narrow band-Internet of Things; NB-IoT) chip. The second communication chip 22 may be a high-speed chip, such as a Long Term Evolution (Long Term Evolution; LTE) chip and a New Radio (NR) chip. The switching unit 23 may be an Application Procedure (AP).

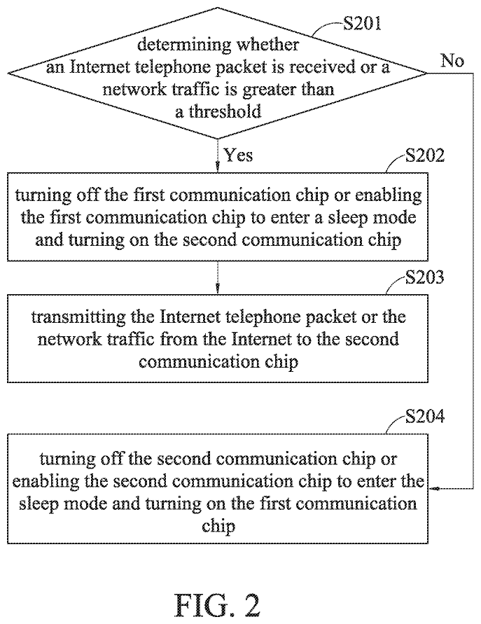

Referring to FIG. 2, a communication method according to an embodiment of the present disclosure is shown. In step S201, whether an Internet telephone packet is received from the Internet or a network traffic from the Internet is greater than a threshold is determined. If yes, the communication method proceeds to step S202. In step S202, the first communication chip is turned off or enters the sleep mode and the second communication chip is turned on. The communication method then proceeds to step S203, in which the Internet telephone packet or the network traffic is transmitted from the Internet to the second communication chip. If no, the communication method proceeds to step S204. In step S204, the second communication chip is turned off or enters the sleep mode and the first communication chip is turned on.

Therefore, since the communication terminal device 2 needs to make a call or transmit a great network traffic of transmission data, the switching unit 23 turns off the first communication chip 21 that is power-saving and turns on the high-speed second communication chip 22 to allow the Internet telephone packet or data to be flown to the high-speed second communication chip 22. Since the call ends or an ordinary network traffic of transmission data is transmitted, the switching unit 23 turns on the power-saving first communication chip 21 and turns off the high-speed second communication chip 22 to allow the data to be flown to the power-saving first communication chip 21.

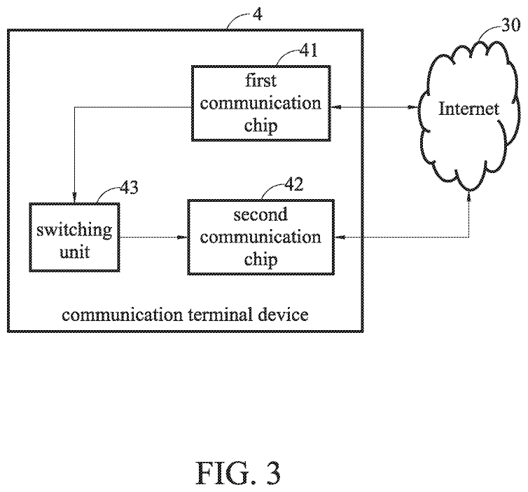

Referring to FIG. 3, a communication terminal device 4 includes a first communication chip 41, a second communication chip 42 and a switching unit 43 according to another embodiment of the present disclosure.

The first communication chip 41 receives the Internet telephone packet or the network traffic transferred from the core network 30 or a paging transmitted from the core network 30. When receiving the Internet telephone packet or the network traffic transferred from the core network 30 or a paging transmitted from the core network 30, the first communication chip 41 is detached from the core network 30 and issues a notification to the switching unit 43. On the contrary, when receiving no Internet telephone packet transferred from the core network 30 or no paging transmitted from the core network 30, the first communication chip 41 is not detached from the core network 30.

In response to the notification issued by the first communication chip 41, the switching unit 43 awakes the second communication chip 42 and the core network 30 is attached to the second communication chip 42 so as to enable the Internet telephone packet or the network traffic to be transmitted from the core network 30 to the second communication chip 42.

When being in an active mode or in a non-idle mode, the first communication chip 41 may be detached from the core network 30. When being in an inactive mode or an idle mode, the first communication chip 41 establishes a Random Access Channel (RACH) first, and is then detached from the core network 30.

In the core network 30, a Proxy-Call Session Control Function (Proxy-CSCF) in a Call Session Control Function (CSCF) or a Serving Gateway (S-GW)/Packet Data Network Gateway (P-GW) is in charge of transferring or transmitting the Internet telephone packet or the network traffic to the communication terminal device 4, and a Mobility Management Entity (MME) is in charge of issuing a paging to the communication terminal device 4.

In a Home Subscriber Server (HSS) of the core network 30, the first communication chip 41 and the second communication chip 42 are tagged to be an identical communication terminal device 4, and the P-CSCF may search and record that the first communication chip 41 and the second communication chip 42 are the same communication terminal device 4. Therefore, the communication terminal device 4 may switch the first communication chip 41 and second communication chip 42 to be attached to or detached from the core network 30.

The communication terminal device 4 may be a wearable device or a portable device, including an electronic device, such as a mobile phone having a communication function. The Internet telephone packet is referred to a packet based on a Session Initial Protocol (SIP). The first communication chip 41 may be a power-saving chip, such as a Narrow Band Internet of Things (NB-IoT) chip. The second communication chip 42 may be a high-speed chip, such as a Long Term Evolution (LTE) chip. The switching unit 43 may be an Application Procedure (AP).

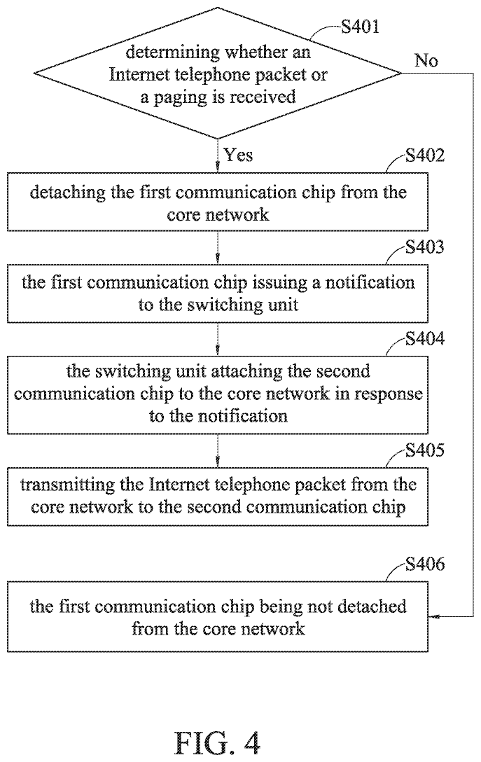

Referring to FIG. 4, a communication method according to another embodiment of the present disclosure is shown. In step S401, whether an Internet telephone packet or a paging is received from the core network is determined. If yes, the communication method proceeds to step S402. In step S402, the first communication chip is detached from the core network. The communication method then proceeds to step S403. If no, the communication method proceeds to step S406, in which the first communication chip is not detached from the core network. In step S403, the first communication chip issues a notification to the switching unit. The communication method then proceeds to step S404. In step S404, in response to the notification issued from the first communication chip, the switching unit enables the second communication chip to be attached to the core network. The communication method then proceeds to step S405. In step S405, the Internet telephone packet is transmitted from the core network to the second communication chip.

In the communication terminal device and the communication method according to the present disclosure, when the communication terminal device 4 needs to make a call or a great network traffic of transmission data, through a paging of the core network 30, the first communication chip 41 that is power-saving is turned off and the switching unit 43 turns on the high-speed second communication chip 42, to enable the Internet telephone packet or the data to be flown to the high-speed second communication chip 42. When the call ends or an ordinary network traffic of data is transmitted, through a paging of the core network 30, the power-saving first communication chip 41 is turned on and the switching unit 43 turns off the high-speed second communication chip 42, so as to enable the data to be flown to the power-saving first communication chip 41.

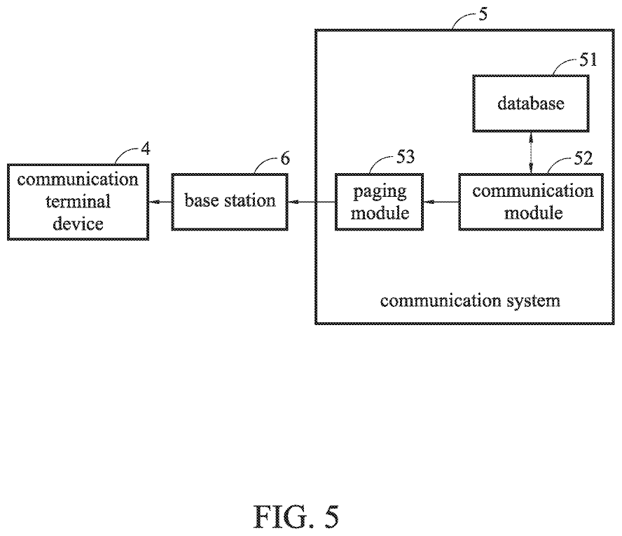

Referring to FIG. 5, a communication system 5 includes a database 51, a communication module 52 and a paging module 53 according to an embodiment of the present disclosure.

In an embodiment of the present disclosure, the database 51 is a Home Subscriber Server (HSS), including association information of a first identification code and a second identification code, which are International Mobile Subscriber Identity (IMSI). In another embodiment of the present disclosure, the first identification code is a message that the first communication chip of the communication terminal device 4 registers to the communication system 5, the second identification code is a message that the second communication chip of the communication terminal device 4 registers to the communication system 5, and the communication system 5 can be deemed as the core network.

In an embodiment of the present disclosure, the communication module 52 is a Proxy-Call Session Control Function (Proxy-CSCF) in a Call Session Control Function (CSCF) or a Serving Gateway (S-GW)/Packet Data Network Gateway (P-GW), and may search the database 51 for the association information to obtain the first identification code associated with the second identification code when receiving an Internet telephone packet with the second identification code. When the first communication chip of the communication terminal device 4 is in the active mode or the non-idle mode, the communication module 52 transforms an Internet telephone packet having the second identification code into an Internet telephone packet having the first identification code, and transfers the Internet telephone packet with the first identification code to the first communication chip. When the first communication chip is in the inactive mode or in the idle mode, the communication module 52 issues a notification with the first identification code to the paging module 53. When the second communication chip of the communication terminal device 4 is still attached to the communication system 5, the communication module 52 further transmits an Internet telephone packet with the second identification code to the second communication chip.

In an embodiment of the present disclosure, the paging module 53 is a Mobility Management Entity (MME), and, when receiving from the communication module 52 the notification with the first identification code, transmits a paging with the first identification code to the first communication chip. During the process of the paging module 53 transmitting the paging to the first communication chip, the paging module 53 may page a base station 6 first, such as an Evolution Node B (eNB) and a Generation Node B (gNB), and then the base station 6 transmits the paging with the first identification code to the first communication chip. When the second communication chip is still attached to the communication system 5, the paging module 53 further pages the second communication chip first, and the communication module 52 transmits an Internet telephone packet with the second identification code to the second communication chip.

In an embodiment of the present disclosure, the MME may page one or more eNBs to search a possible area of the first communication chip of the communication terminal device 4. After the eNB where the communication terminal device 4 is located is found, the eNB pages the first communication chip of the communication terminal device 4 to enable the first communication chip to be attached to the core network, or to establish an RACH first and then to enable the first communication chip to be detached from the core network. Subsequently, the switching unit of the communication terminal device awakes the second communication chip of the communication terminal device 4 to enable the second communication chip to be attached to the communication system 5 and then receive an Internet telephone packet or a network traffic from the communication system 5.

Through the installation of a switching mechanism in the communication module 52 of the communication system 5, i.e., the association between the second identification code and the first identification code, the communication system 5 may communicate with the first communication chip of the communication terminal device 4 first, and then the switching unit 23 awakes the second communication chip in response to the notification issued from the first communication chip to be attached to the communication system 5.

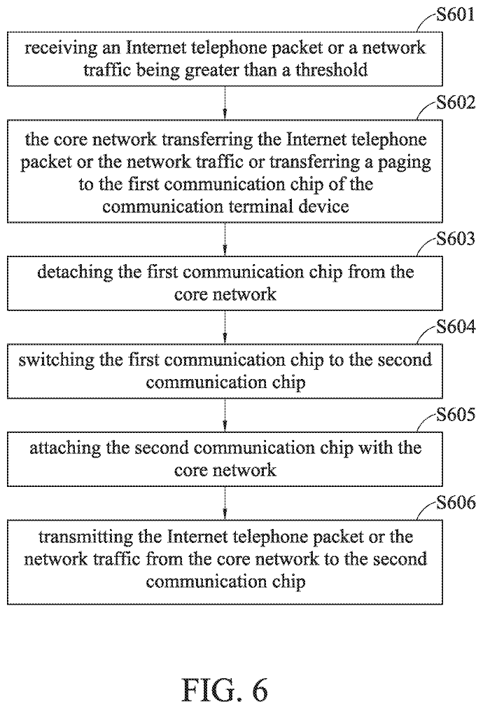

Referring to FIG. 6, a communication method according to an embodiment of the present disclosure is shown. In step S601, the core network receives an Internet telephone packet or a network traffic greater than a threshold. The communication method proceeds to step S602. In step S602, the core network transfers the Internet telephone packet or the network traffic or transfers a paging to the first communication chip of the communication terminal device. The communication method proceeds to step S603. In step S603, the first communication chip is detached from the core network. The communication method proceeds to step S604. In step S604, it is switched from the first communication chip to the second communication chip. The communication method proceeds to step S605. In step S605, the second communication chip is attached to the core network. The communication method proceeds to step S606. In step S606, the Internet telephone packet or the network traffic is transmitted from the core network to the second communication chip.

In summary, the core network issues a switching command to the communication terminal device, and the communication terminal device makes a call by using the high-speed second communication chip (e.g., an LTE chip), which is switched from the first communication chip (e.g., an NB-IoT chip).

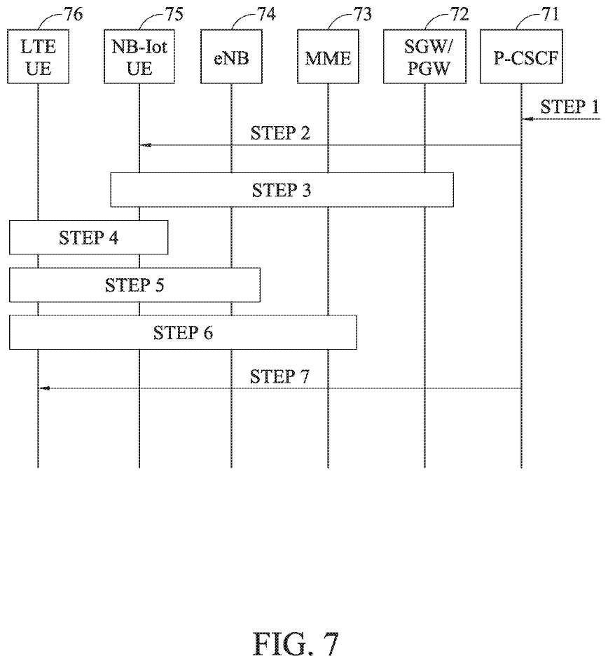

FIGS. 7-10 illustrate a communication method applied to a core network according to an embodiment of the present disclosure. The core network includes a Proxy-Call Session Control Function (P-CSCF) 71, a Serving Gateway (SGW)/Packet Data Network Gateway (PGW) 72, and a Mobility Management Entity (MME) 73. The communication terminal device includes a Narrow Band Internet of Things User Equipment (NB-IoT UE) 75 and a Long Term Evolution User Equipment (LTE UE) 76. Between the core network and the communication terminal device is an Evolution Node B (eNB) 74.

As shown in FIG. 7, the NB-IoT UE 75 and the LTE UE 76 use different International Mobile Subscriber Identities (IMSIs). For instance, the NB-IoT UE 75 uses IMSI #1, while the LTE UE 76 uses IMSI #2. FIG. 7 shows that the NB-IoT UE 75 is in the active mode or in the non-idle mode, and the NB-IoT UE 75 has been registered to the core network and has an IP address.

In STEP 1, the P-CSCF 71 receives SIP INVITE (having IMSI #2), and the P-CSCF 71, after searching HSS, knows that the current NB-IoT UE 75 has been registered and has an IP address. Then, in STEP 2, the P-CSCF 71 transforms the IMSI #2 into IMSI #1, and transfers the SIP INVITE (having the IMSI #1) to the NB-IoT UE 75. In STEP 3, when receiving the SIP INVITE from the P-CSCF 71, the NB-IoT UE 75 is detached from the SGW/PGW 72, as the NB-IoT UE 75 does not support VoLTE application service. Then, in STEP 4, the NB-IoT is switched to the LTE protocol. In STEP 5, the LTE UE 76 starts to execute a random access procedure. In STEP 6, the LTE UE 76 executes an attach procedure. Now the LTE UE 76 has an IP address. Finally, in STEP 7, the P-CSCF 71, after searching the HSS, knows that the current LTE UE 76 is already registered and has an IP address, and the P-CSCF 71 will transfer the original SIP INVITE (having the IMSI #2) to the LTE UE 76 and establish a VoLTE service.

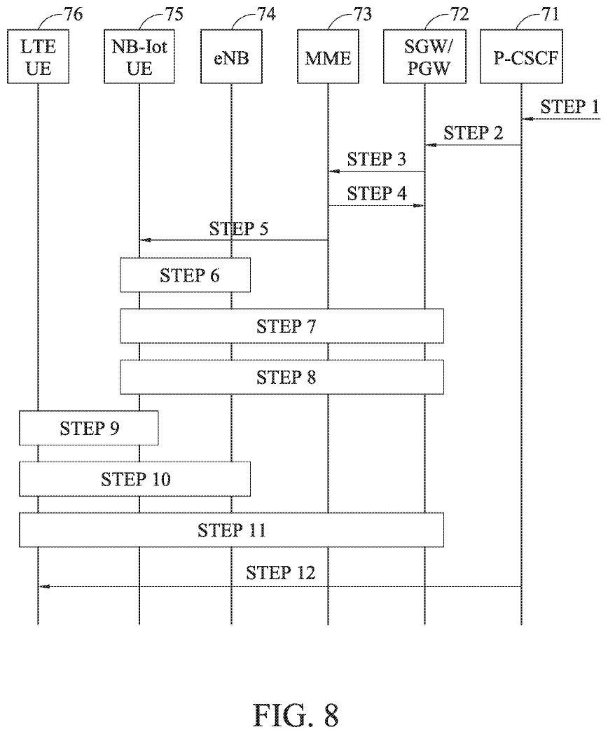

As shown in FIG. 8, the NB-IoT UE 75 and the LTE UE 76 use different International Mobile Subscriber Identities (IMSIs). For instance, the NB-IoT UE 75 uses the IMSI #1, while the LTE UE 76 uses the IMSI #2. FIG. 8 shows that the NB-IoT UE 75 is in an inactive mode or in an idle mode, and the NB-IoT UE 75 has been registered to the core network while the P-CSCF 71 does not know the IP address of the NB-IoT UE 75 yet.

In STEP 1, the P-CSCF 71 receives SIP INVITE (having the IMSI #2), and the P-CSCF 71, after searching HSS, knows that the current NB-IoT UE 75 is registered but has no IP address yet. In STEP 2, the P-CSCF 71 transforms the IMSI #2 to the IMSI #1, and transfers SIP INVITE (having the IMSI #1) to the SGW/PGW 72. In STEP 3, the SGW/PGW 72, after receiving the SIP INVITE, will issue a Downlink Data Notification (having the IMSI #1) to the MME 73. In STEP 4, the MME 73 sends a Downlink Data Notification Ack back to SGW/PGW 72, indicating that the Downlink Data Notification is received. In STEP 5, the MME 73 issues a paging (having the IMSI #1) to the eNB 74 where the IMSI #1 is located, and the eNB 74 issues a paging (having the IMSI #1) to the NB-IoT UE 75. When receiving the paging from the MME 73, the NB-IoT UE 75 executes a Random Access Procedure in STEP 6 and an Attach Procedure in STEP 7. Then, in STEP 8, the Detach procedure is executed. Then, in STEP 9, the NB-IoT is switched to the LTE protocol. Then, the LTE UE 76 executes the random access procedure) in STEP 10 and executes the attach procedure in STEP 11. Now the LTE UE has an IP address. Finally, in STEP 12, the P-CSCF 71, after searching HSS, knows that the current LTE UE 76 is registered and has an IP address, and transfers the original SIP INVITE (having the IMSI #2) to the LTE UE 76 and establishes the VoLTE service.

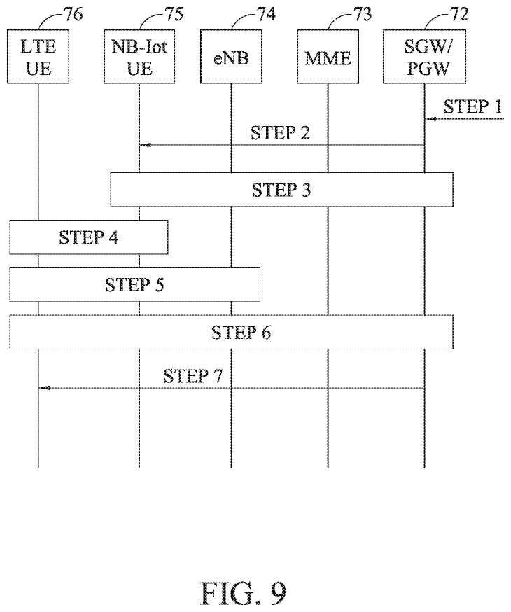

As shown in FIG. 9, the NB-IoT UE 75 and the LTE UE 76 use different International Mobile Subscriber Identities (IMSIs). For instance, the NB-IoT UE 75 uses the IMSI #1, while the LTE UE 76 uses the IMSI #2. As shown in FIG. 9, the NB-IoT UE 75 is in the active mode or in the non-idle mode, and the NB-IoT UE 75 has been registered to the core network and has an IP address. FIG. 7 differs from FIG. 9 in that the switching mechanism of FIG. 7 is in the P-CSCF 71, while the switching mechanism of FIG. 9 is in the SGW/PGW 72.

In STEP 1, the SGW/PGW 72 receives the SIP INVITE (having the IMSI #2), and the SGW/PGW 72, after searching HSS, knows that the current NB-IoT UE 75 is registered and has an IP address. Then, in STEP 2, the SGW/PGW 72 transforms the IMSI #2 to the IMSI #1, and transfers the SIP INVITE (having the IMSI #1) to the NB-IoT UE 75. In STEP 3, when receiving the SIP INVITE from the SGW/PGW 72, the NB-IoT UE 75 is detached from SGW/PGW 72 as the NB-IoT UE 75 does not support the VoLTE application service. Then, in STEP 4, the NB-IoT is switched to the LTE protocol. The LTE UE 76 starts to execute a random access procedure in STEP 5, and executes a random access procedure in STEP 6 and has an IP address since. Finally, in STEP 7, the SGW/PGW 72, after searching HSS, knows that the current LTE UE 76 is registered and has an IP address; and the SGW/PGW 72 will transfer the original SIP INVITE (having the IMSI #2) to the LTE UE 76 and establish the VoLTE service.

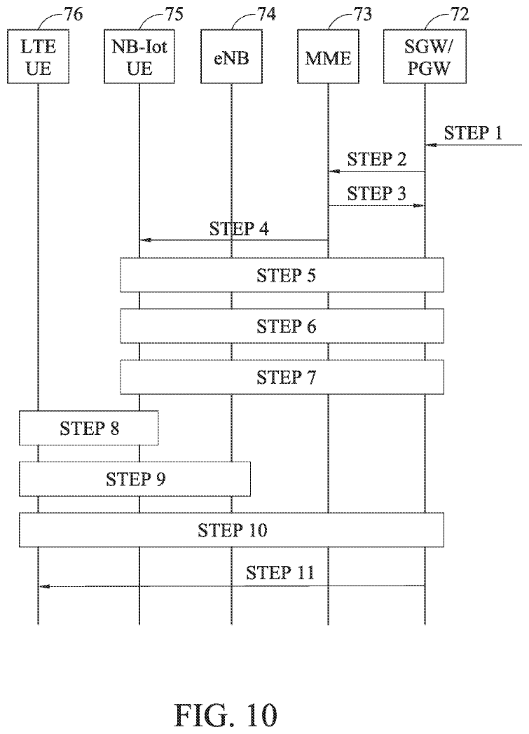

As shown in FIG. 10, the NB-IoT UE 75 and the LTE UE 76 use different International Mobile Subscriber Identities (IMSIs). For instance, the NB-IoT UE 75 uses the IMSI #1, while the LTE UE 76 uses the IMSI #2. FIG. 8 shows that the NB-IoT UE 75 is in the inactive mode or the idle mode, the NB-IoT UE 75 has been registered to the core network but the P-CSCF 71 does not know the IP address of the NB-IoT UE 75 yet. FIG. 8 differs from FIG. 10 in that the switching mechanism of FIG. 8 is in the P-CSCF 71, while the switching mechanism of FIG. 10 is in the SGW/PGW 72.

In STEP 1, the SGW/PGW 72 receives the SIP INVITE (having the IMSI #2), and, after searching HSS, knows that the current NB-IoT UE 75 is registered but has no IP address yet. Then, in STEP 3, the SGW/PGW 72 issues a Downlink Data Notification (having the IMSI #1) to the MME 73. In STEP 3, the MME 73 sends a Downlink Data Notification Ack back to the SGW/PGW 72, indicating that the Downlink Data Notification is received. In STEP 4, the MME 73 issues a Paging (having the IMSI #1) to the eNB 74 where the IMSI #1 is located, and the eNB 74 issues a Paging (having the IMSI #1) to the NB-IoT UE 75. When receiving a Paging from the MME 73, the NB-IoT UE 75 executes a random access procedure in STEP 5 and executes a random access procedure in STEP 6. Then, in STEP 6, a Detach procedure is executed. Then, in STEP 8, the NB-IoT is switched to an LTE protocol. Then, the LTE UE 76 executes a random access procedure in STEP 9, and executes an attach procedure in STEP 10. Now the LTE UE has an IP address. Finally, in STEP 11, the SGW/PGW 72, after searching HSS, knows that the current LTE UE 76 is registered and has an IP address, and the GW/PGW 72 transfers the original SIP INVITE (having the IMSI #2) to the LTE UE 76 and establishes the VoLTE service.

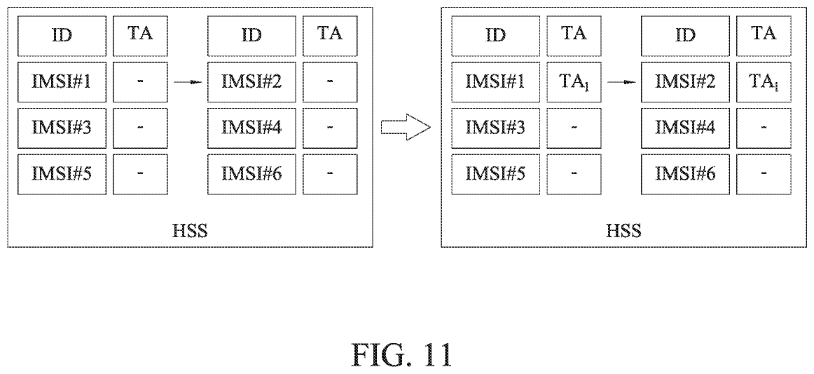

FIG. 11 shows the association information of the first identification code and the second identification code11 in a communication system and a communication method according to the present disclosure. A Home Subscriber Server (HHS) of the communication system includes association information of the first identification code and the second identification code. As shown in FIG. 11, in the communication terminal device the NB-IoT UE uses the IMSI #1 while the LTE UE uses the IMSI #2. The left block of FIG. 11 shows that the HSS associates the NB-IoT UE using the IMSI #1 with the LTE UE using the IMSI #2. The right block of FIG. 11 shows that when the MME updates the position TA1 of the NB-IoT UE, the HSS will update the position TA1 of the LTE UE simultaneously.

In summary, when a communication terminal device, a communication system and a communication method according to the present disclosure make a call or have a great amount of data, the communication terminal device may be switched from the power-saving mode to the high-speed mode; and when the call ends or only an ordinary amount of data is transmitted, the communication terminal device may be switched from the high-speed mode to the power-saving mode.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A communication terminal device, comprising:
a first communication chip;
a second communication chip; and
a switching unit for detecting an Internet telephone packet or a network traffic, wherein the first communication chip is turned off or in a sleep mode and the second communication chip is turned on to allow the Internet telephone packet or the network traffic to be transmitted from an Internet to the second communication chip if the network traffic greater than a threshold or the Internet telephone packet is detected; or, otherwise, the second communication chip is turned off or in the sleep mode and the first communication chip is turned on.

2. The communication terminal device of claim 1, wherein the first communication chip is a power-saving chip, and the second communication chip is a high-speed chip.

3. The communication terminal device of claim 1, wherein the first communication chip is a Narrow Band Internet of Things (NB-IoT) chip, the second communication chip is a Long Term Evolution (LTE) chip, and the switching unit is an Application Procedure (AP).

4. A communication terminal device, comprising:
a first communication chip detached from a core network and emitting a notification when a network traffic greater than a threshold, an Internet telephone packet or a paging being received;
a second communication chip; and
a switching unit, in response to the notification issued by the first communication chip, enabling the second communication chip to be attached to the core network to allow the Internet telephone packet or the network traffic to be transmitted from the core network to the second communication chip.

5. The communication terminal device of claim 4, wherein the first communication chip is a power-saving chip, and the second communication chip is a high-speed chip.

6. The communication terminal device of claim 4, wherein the first communication chip is a Narrow Band Internet of Things (NB-IoT) chip, the second communication chip is a Long Term Evolution (LTE) chip or a New Radio (NR) chip, and the switching unit is an Application Procedure (AP).

7. The communication terminal device of claim 4, wherein when the first communication chip is in an active mode or a non-idle mode, the first communication chip is detached from the core network, and when the first communication chip is in an inactive mode or an idle mode, a Random Access Channel (RACH) is established and then the core network is detached.

8. The communication terminal device of claim 4, wherein information that the first communication chip and the second communication chip are an identical communication terminal device is recorded in the core network.

9. A communication system, comprising:
a database comprising association information having a first identification code and a second identification code; and
a communication module for searching the database for the association information when receiving an Internet telephone packet having the second identification code to obtain the first identification code associated with the second identification code, and transforming the Internet telephone packet having the second identification code into an Internet telephone packet having the first identification code when the first communication chip of the communication terminal device is in an active mode or in a non-idle mode and transferring the Internet telephone packet having the first identification code to the first communication chip, and the communication module further transferring an Internet telephone packet having the second identification code to a second communication chip when the second communication chip of the communication terminal device is still attached to the communication system.

10. The communication system of claim 9, further comprising a paging module, wherein when the first communication chip is in an inactive mode or an idle mode, the communication module issues a notification with the first identification code to the paging module to enable the paging module to transmit a call with the first identification code to the first communication chip, and when the second communication chip is still attached to the communication system, the paging module calls the second communication chip first and then the communication module transmits an Internet telephone packet having the second identification code to the second communication chip.

11. The communication system of claim 10, wherein the paging module transfers a call with the first identification code to a base station, and the base station transfers the call having the first identification code to the first communication chip.

12. The communication system of claim 11, wherein the database is a Home Subscriber Server (HSS), the communication module is a Call Session Control Function (CSCF) or Gateway (GW), the paging module is a Mobility Management Entity (MME), and the base station is an Evolution Node B (eNB) or a Generation Node B (gNB).

13. A communication method, comprising:
after a core network receiving an Internet telephone packet or a network traffic greater than a threshold, the core network transferring the Internet telephone packet or the network traffic or transmitting a paging to a first communication chip of a communication terminal device;
the first communication chip being detached from the core network;
switching from the first communication chip to a second communication chip;
the second communication chip being attached to the core network; and
transmitting the Internet telephone packet or the network traffic from the core network to the second communication chip.

14. The communication method of claim 13, wherein the Internet telephone packet and the network traffic are received, transferred and transmitted by a Call Session Control Function (CSCF) or a Gateway (GW) of the core network, and the paging is transmitted by a Mobility Management Entity (MME) of the core network.

15. The communication method of claim 14, further comprising transferring the Internet telephone packet or the network traffic to the first communication chip by the Call Session Control Function or the Gateway prior to the first communication chip being detached from the core network when the first communication chip of the communication terminal device is in an active mode or in a non-idle mode.

16. The communication method of claim 14, further comprising transferring the Internet telephone packet or the network traffic to the Mobility Management Entity (MME) by the Call Session Control Function or the Gateway to enable the Mobility Management Entity to transmit the paging to the first communication chip and to allow the first communication chip to establish a Random Access Channel (RACH) prior to the first communication chip be detached from the core network when the first communication chip of the communication terminal device is in an inactive mode or in an idle mode.

17. The communication method of claim 16, wherein the Mobility Management Entity transmitting the paging to the first communication chip comprises: the Mobility Management Entity paging a base station and the base station paging the first communication chip.

18. The communication method of claim 14, wherein the Internet telephone packet or the network traffic transmitting the core network to the second communication chip comprises: the Mobility Management Entity paging the second communication chip to transfer the Internet telephone packet or the network traffic to the second communication chip.

19. The communication method of claim 13, wherein receiving the Internet telephone packet or the network traffic greater than a threshold and the core network transferring the Internet telephone packet or the network traffic or transferring a paging to the first communication chip of the communication terminal device comprise:
the core network receiving an Internet telephone packet with a second identification code, and searching a first identification code associated with the second identification code based on the second identification code; and
the core network transmitting to the first communication chip a paging with the first identification code or an Internet telephone packet with the first identification code transferred from an Internet telephone packet with the first identification code.

20. The communication method of claim 19, wherein transmitting the Internet telephone packet or the network traffic from the core network to the second communication chip comprises: the core network transmitting an Internet telephone packet with the second identification code to the second communication chip.
